(19) United States
(12) Patent Application Publication
(10) Pub. No.: US 2020/0382660 A1
(43) Pub. Date: Dec. 3, 2020

(54) IMAGE PROCESSING APPARATUS AND RECORDING MEDIUM

(71) Applicant: KONICA MINOLTA, INC., Tokyo (JP)

(72) Inventor: Kenzo YAMAMOTO, Toyohashi-shi (JP)

(73) Assignee: KONICA MINOLTA, INC., Tokyo (JP)

(21) Appl. No.: 15/930,485

(22) Filed: May 13, 2020

(30) Foreign Application Priority Data
Jun. 3, 2019 (JP) 2019-103859

(51) Int. Cl. H04N 1/00

(52) U.S. Cl. CPC H04N 1/00403; H04N 1/00474; H04N 1/00482

(57) ABSTRACT

An image processing apparatus includes: a first processor that outputs an audio question for a user from a speech output device; a third processor that receives a spoken response of the user to the audio question, the spoken response being inputted from a speech input device; and a second processor that takes an appropriate image processing action to the spoken response received by the third processor. A first mode and a second mode are supported, and the second mode is limited in possible responses to the audio question, as contrasted with the first mode. The image processing apparatus further includes a fourth processor that switches between the first mode and the second mode. The first processor outputs the audio question for the user from the speech output device in the first or second mode being selected by the fourth processor.

The disclosure of Japanese Patent Application No. 2019-103859 filed on Jun. 3, 2019, including description, claims, drawings, and abstract, is incorporated herein by reference in its entirety.

### BACKGROUND

### Technological Field

The present invention relates to an image processing apparatus such as a copier, a printer, and a multifunctional digital machine that is referred to as a multi-function peripheral (MFP); and a recording medium.

### Description of the Related Art

More and more voice-controlled apparatuses are becoming used as such image processing apparatuses described above. Specifically, such an image processing apparatus outputs an audio question from a speech output device such as a speaker, receives a user's spoken response from a speech input device such as a microphone, performs speech recognition, and takes an appropriate action to the user's spoken response such as configuring settings or issuing a command.

However, when the speech input device such as a microphone inputs the user's spoken response, it also inputs the background noise surrounding the image processing apparatus. For example, the image processing apparatus may be an image forming apparatus having a scanner, a printer, and the like; in this case, the speech input device inputs an operational sound as noise from the image forming apparatus during document scan or printing. Depending on the noise level, the image forming apparatus can fail in correctly identifying a user's spoken response that is inputted from the speech input device such as a microphone and takes a wrong action.

To solve this problem, Japanese Unexamined Patent Application Publication No. 2010-136335 suggests an image forming apparatus: when a spoken instruction is given by a user, the image forming apparatus protects the accuracy of speech recognition from operational noise from a device in operation, by stopping the device.

The technique taught by Japanese Unexamined Patent Application Publication No. 2010-136335, however, is a method of stopping a device in operation for speech recognition when a spoken instruction is given by a user; it makes the device slow to complete a job. This interferes with high-volume or emergency printing.

### SUMMARY

The present invention, which has been made in consideration of such a technical background as described above, is aimed at providing an image forming apparatus and a recording medium that are capable of protecting the accuracy of speech recognition from the background noise level surrounding the image forming apparatus, without the need of stopping the operation of the image forming apparatus during speech input, when a user's speech is inputted from a speech input device such as a microphone.

A first aspect of the present invention relates to an image processing apparatus including:
a first processor that outputs an audio question for a user from a speech output device;
a third processor that receives a spoken response of the user to the audio question, the spoken response being inputted from a speech input device; and
a second processor that takes an appropriate image processing action to the spoken response received by the third processor,
   wherein a first mode and a second mode are supported, and the second mode is limited in possible responses to the audio question, as contrasted with the first mode, the image processing apparatus further including a fourth processor that switches between the first mode and the second mode, wherein the first processor outputs the audio question for the user from the speech output device in the first or second mode being selected by the fourth processor.

A second aspect of the present invention relates to a non-transitory computer-readable recording medium storing a program for a computer of an image processing apparatus to execute:
outputting an audio question for a user from a speech output device;
receiving a spoken response of the user to the audio question, the spoken response being inputted from a speech input device; and
taking an appropriate image processing action to the spoken response being received,
   wherein a first mode and a second mode are supported, and the second mode is limited in possible responses to the audio question, as contrasted with the first mode, the program for the computer to further execute switching between the first mode and the second mode, wherein the audio question is outputted from the speech output device in the first or second mode being selected.

### BRIEF DESCRIPTION OF THE DRAWINGS

The advantages and features provided by one or more embodiments of the invention will become more fully understood from the detailed description given hereinbelow and the appended drawings which e given by way of illustration only, and thus are not intended as a definition of the limits of the present invention.

FIG. 1 illustrates a configuration of an image processing apparatus according to one embodiment of the present invention.

FIG. 2 is an example of a series of audio questions and spoken responses exchanged between the image processing apparatus and a user in a first mode.

FIG. 3 is a graph indicating an example of operational sound levels from the image processing apparatus.

FIG. 4 is an example of a series of audio questions and spoken responses exchanged between the image processing apparatus and a user when the image processing apparatus switches to a second mode during speech input.

FIG. 5 illustrates possible responses displayed on a display.

FIG. 6 is another example of a series of audio questions and spoken responses exchanged between the image processing apparatus and a user when the image processing apparatus switches to the second mode during speech input.

FIG. 7 is a flowchart representing an example of operation of the image processing apparatus, switching between the first mode and the second mode during speech input.

FIG. 8 is a flowchart representing another example of the operations of the image processing apparatus, switching between the first mode and the second mode during speech input.

FIG. 9 is a graph indicating an example of a change in operational sound level (noise level) from a job.

FIG. 10 is a flowchart representing the operation of the image processing apparatus, calculating, a noise level from a job to be a past operational sound level and performing mode switching depending on the calculated noise level.

FIG. 11 is a mph indicating another example of a change in operational sound level (noise level) from a job.

FIG. 12 is a flowchart representing the operation of the image processing apparatus, selecting the second mode before the start of a job.

FIG. 13 illustrates a preference screen for the user to select auto or manual for switching between the first mode and the second mode.

FIG. 14 illustrates a mode preference screen to be displayed when the user selects “manual” via the preference screen of FIG. 13.

### DETAILED DESCRIPTION OF EMBODIMENTS

Hereinafter, one or more embodiments of the present invention will be described with reference to the drawings. However, the scope of the invention is not limited to the disclosed embodiments.

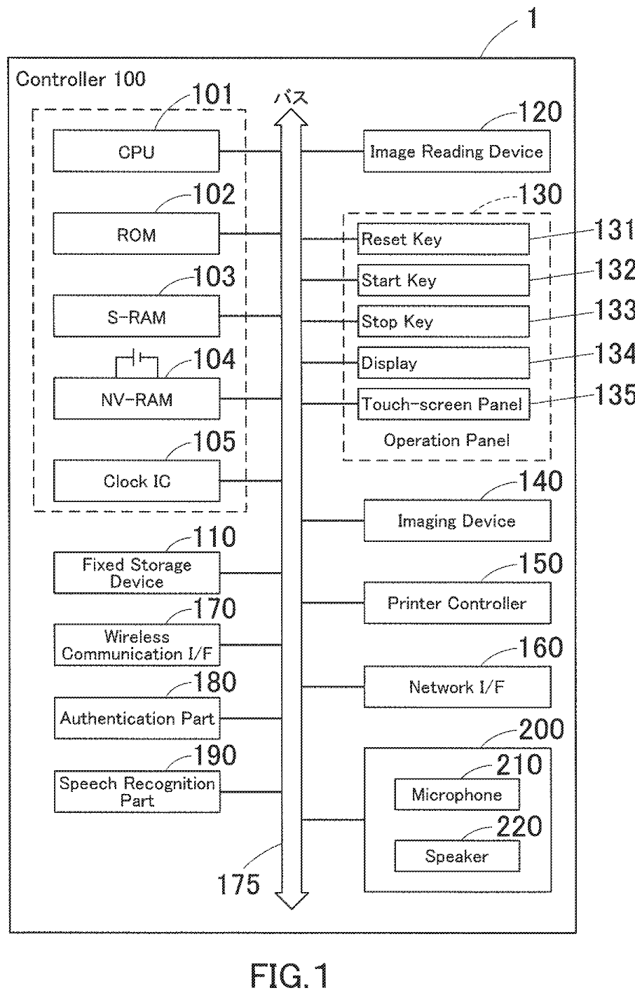

FIG. 1 is a block diagram illustrating a configuration of an image forming apparatus 1 as an image processing apparatus according to one embodiment of the present invention. In this embodiment, a multi-functional digital machine having a copier function, a printer function, a facsimile function, a scanner function, and other functions as described above, is employed as an image forming apparatus 1.

As illustrated in FIG. 1, the image forming apparatus 1 is essentially provided with: a controller 100; a storage device 110; an image reading device 120; an operation panel 130; an imaging device 140; a printer controller 150; a network interface (network I/F) 160; a wireless communication interface (wireless communication I/F) 170; an authentication part 180; a speech recognition part 190; and a speech terminal device 200, all of which are connected to each other through a system bus 175.

The controller 100 is essentially provided with: a central processing unit (CPU) 101; a read-only memory (ROM) 102; a static random-access memory (S-RAM) 103; a non-volatile random-access memory (NV RAM) 104; and a clock IC 105.

The CPU 101 controls the image forming apparatus 1 in a unified and systematic manner by executing operation programs stored on a recording medium such as the ROM 102. For example, the CPU 101 controls the image forming apparatus 1 in such a manner that allows its copier, printer, scanner, and facsimile function to run properly. Furthermore, in this embodiment, the CPU 101 performs: outputting art audio question from the speech terminal device 200 when a user starts to operates the image forming apparatus 1; receiving the user's speech input i.e. the user's spoken response to the audio question from the speech terminal device 200; identifying the speech by the speech recognition part 190; and taking an appropriate image processing action to the identified speech such as configuring job settings or issuing a command. The CPU 101 farther switches between a first mode and a second mode in which different series of audio questions are outputted from the speech terminal device 200. These operations will be later described in detail.

The ROM 102 stores programs for the CPU 101 to execute and other data.

The S-RAM 103 serves as a workspace for the CPU 101 to execute programs, essentially stores programs and data to be used by the programs for a short time.

The NV-RAM 104 is a battery backed-up non-volatile memory and essentially stores various settings related to image forming.

The clock IC 105 indicates time and also serves as an internal timer to measure the processing time, for example.

The storage device 110 consists of a hard disk drive, for example, and stores programs and data of various types. Specifically, in this embodiment, the CPU 101 supports the first mode and the second mode, in which different series of audio questions are outputted from the speech terminal device 200. A series of audio questions to he outputted in the first mode and another series of audio questions to be outputted the second mode are stored for each user-configurable item.

The image reading device 120 is essentially provided with a scanner, and it obtains an image by scanning a document put on a platen and converts the obtained image into an image data format.

The operation panel 130 allows the user to give instructions such as jobs to the image forming apparatus 1 and to configure various settings of the image forming apparatus 1. The operation panel 130 is essentially provided with: a reset key 131; a start key 132; a stop key 133; a display 134; and a touch-screen panel 135.

The reset key 131 allows the user to reset the settings. The start key 132 allows the user to start a job, for example, document scan. The stop key 133 allows the user to stop an operation.

The display 134 is a liquid-crystal display device, for example, displaying messages, various operation screens, and other information. The touch-screen panel 135 is disposed on the display screen of the display 134, and detects a user touch event.

The imaging device 140 prints on paper image data obtained from a document by the image reading device 120 and a copy image that is formed on the basis of prim data received from a terminal apparatus 3.

The printer controller 150 creates a copy of an image on the basis of print data received by the network interface 160.

The network interface (network I/F) 160 serves as a transceiver that performs communication with external apparatuses such as user terminals through a network 3. The wireless communication I/F 170 is an interface that performs communication with external apparatuses using near-field wireless communication technology.

The authentication part 180 obtains identification information of it user who intends to logon, and performs authentication by comparing the identification information to proof information stored on a recording medium, such as the fixed storage device 110. Instead of the authentication part 180, an external authentication server may perform authentication by comparing the identification information to the proof information; in this case, the authentication part 180 performs authentication by receiving a result of the authentication from the authentication server.

When a user's speech input is received from the speech terminal device 200, the speech recognition part 190 performs speech re-cognition in a heretofore known method and thereby identifies the speech (voice). An external apparatus such as a personal computer, instead of the image forming apparatus 1, may be configured to perform speech recognition; in this case, the image forming apparatus 1 is configured to receive a result of speech recognition therefrom.

The speech terminal device 200 is provided with: a microphone 210 serving as a speech input device; and a speaker 220 serving as a speech output device. The microphone 210 inputs a user's speech along with background noise including an operational sound from the image forming apparatus 1, and transfers the speech input to the speech recognition part 190 as commanded by the controller 100. The speaker 220 outputs a speech such as an audio question as commanded by the controller 100.

The speech terminal device 200 may be provided outside of the image forming apparatus 1 instead of inside thereof; in this case, the speech terminal device 200 is connected to the image forming apparatus 1 directly or indirectly, in a wired or wireless manner.

The image forming apparatus 1 illustrated in FIG. 1 supports the first mode and the second mode. Hereinafter, the first mode and the second mode, in which different series of audio questions are outputted from the speech terminal device 200, be described.

In this embodiment, the first mode is an open-ended question mode. The open-ended question mode prompts a user to respond to an audio question with a free-form spoken response. For example, an audio question is outputted as “destination address?” to fix an address for scan to email. The user is thus prompted to respond to the audio question with “tanaka@xxx”, “send it to Mr. tanaka”, “send it to Mr. Tanaka by email”, or the like as a free-form spoken response. This is convenient for users. For another example, an audio question is outputted as “how many copies you need?” or “paper size?” to fix information for copying. Similar to the example above, the user is thus prompted to say the number of copies or a paper size as a free-form spoken response.

In contrast, in this embodiment, the second mode is a closed-ended question mode prompting a user to respond with a spoken response selected from possible responses. For example, an audio question is outputted as “select from the following addresses” to fix an address for scan to email and, at the same time, multiple possible responses are presented as “(i) tanaka@xxx, (ii) Mr. Tanaka, and (iii) Mr. Suzuki”. The user is thus prompted to respond to the audio question with an address selected front the possible responses. The user may be prompted to say an e-mail address or answer by number. For another example, an audio question is outputted as “select how many copies you need from the list” or “select a paper size from the list” to fix information for copying and, at the same time, multiple possible responses are presented. Similar to the example above, the user is thus prompted to respond with a spoken response selected front the possible responses.

The second mode may prompt a user to respond to an audio question with “Yes” or “No”. In this case, two possible responses, “Yes” and “No” are presented at the same time. The second mode is thus limited in possible responses to the audio question, as contrasted with the first mode, the open-ended question mode. For example, an audio question is outputted as “is it A4” to fix a paper size; when the user says “No” to the question, another audio question is outputted as “is it B4?”. The image forming apparatus 1 thus narrows down the preference for paper size by outputting different questions consecutively.

The image forming apparatus 1 has a dictionary that contains keywords and speech characteristics corresponding to the keywords, and performs speech recognition with reference to the dictionary. As described above, the first mode, the open-ended question mode prompts a user to respond with a free-form spoken response, and this is convenient for users. However, a user needs to respond with a free-form spoken response very carefully such that the image forming apparatus 1 identifies each word correctly and takes keywords therefrom. How long a single response will be is beyond calculation. Furthermore, the image forming apparatus 1 has many functions that sound alike such as “copy”, “copyguard”, and “copy protection”. Depending on the background noise level, the image forming apparatus 1 can fail in speech recognition and stop its operation. This interferes with high-volume or emergency printing.

In contrast, the second mode prompts a user to respond with a spoken response selected from possible responses presented by the image forming apparatus 1. This means, possible keywords are stored in advance on the image forming apparatus 1. In the second mode, the image forming apparatus 1 searches for a keyword having the most similar speech characteristics to that of a user's spoken response, by pattern matching. The image forming apparatus 1 thus identifies the user's spoken response. The image forming apparatus 1 is capable of easily identifying the user's speech by pattern matching, even in the presence of loud noise, since it is from limited possible responses. That is, the second mode is characterized by overcoming background noise as contrasted with the first mode.

In this embodiment, the image forming apparatus 1 is capable of switching between the first mode and the second mode depending on the background noise level when a spoken response is given by a user.

Hereinafter, switching between the first mode and the second mode will be described.

Speech input is enabled by the pressing of a speech input mode button that is displayed or the display 134 of the operation panel 130 but is not shown in the figure. The image farming apparatus 1 proceeds job settings by consecutively exchanging audio questions and spoken responses with a user.

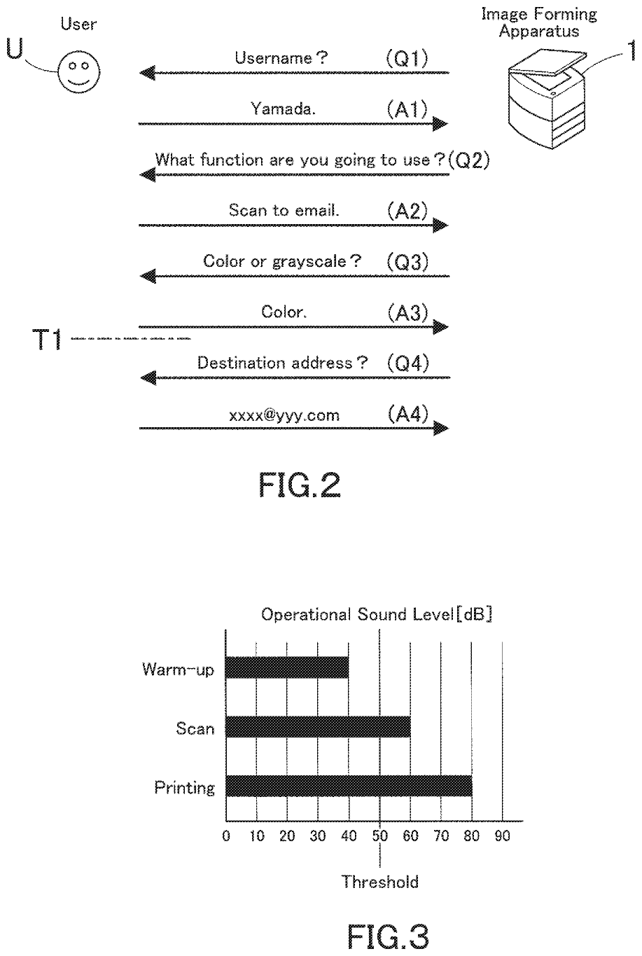

FIG. 2 is an example of a series of audio questions and spoken responses exchanged between the image forming apparatus 1 and a user. In the example of FIG. 2, the background noise level surrounding the image forming apparatus 1 is low. Under circumstances Where the background noise level surrounding the image forming apparatus 1 is low, the image forming apparatus 1 outputs an audio question in the first mode, the open-ended question mode. This is convenient for users because the open-ended question mode prompts a user to respond with a free-form spoken response.

To identify the user first, the image forming apparatus 1 outputs an audio question Q1 “username?” from the speaker 220 of the speech terminal device 200, as referred to FIG. 2. When the user responds with a spoken response A1 “Yamada” for example, the microphone 210 of the speech terminal device 200 inputs the spoken response A1, and the image forming apparatus 1 receives the speech input therefrom. The image forming apparatus 1 then identifies the user as “yamada” by speech recognition or the speech recognition part 190.

Subsequently, the image forming apparatus 1 outputs an audio question Q2 “what function are you going to use?” from the speaker 220. When the user responds with a spoken response A2 “scan to email”, the image forming apparatus 1 receives the speech input. The image forming apparatus 1 then identifies the intended function as document scan and email transmission by speech recognition of the speech recognition part 190.

Subsequently, the image forming apparatus 1 outputs an audio question Q3 “color or grayscale?” from the speaker 220. When the user responds with a spoken response A3 “color”, the image forming apparatus 1 identifies the preference for document scan as color by speech recognition of the speech recognition part 190.

Subsequently, the image forming apparatus 1 outputs an audio question Q4 “destination address?” from the speaker 220. When the user responds with a spoken response A4 “xxxx@yyy.com”, the image forming apparatus 1 identifies the destination address by speech recognition of the speech recognition part 190.

In the above-described manner, the image forming apparatus 1 completes job settings and preferences to be ready to start a job, in accordance with user spoken responses.

It is assumed that, after receiving the user's spoken response A3 “color”, die image forming apparatus 1 starts socument scan by the image reading device 120 at a time T1, in the example above.

FIG. 3 is a graph indicating an example of operational sound levels from the image forming apparatus 1. In this embodiment, the image forming apparatus 1 switches between the first mode and second mode depending on the background noise level whose threshold is 50 decibels (dB), for example. Furthermore, the background noise level goes below the threshold during warm-up, and it goes above the threshold during document scan or priming.

The image forming apparatus 1 receives the background noise from the microphone 210 and measures the background noise. The image firming apparatus 1 judges all the time whether or not the background noise level goes above the threshold. The background noise inputted from the microphone 210 includes operational noise from the image forming apparatus 1 and from other apparatuses.

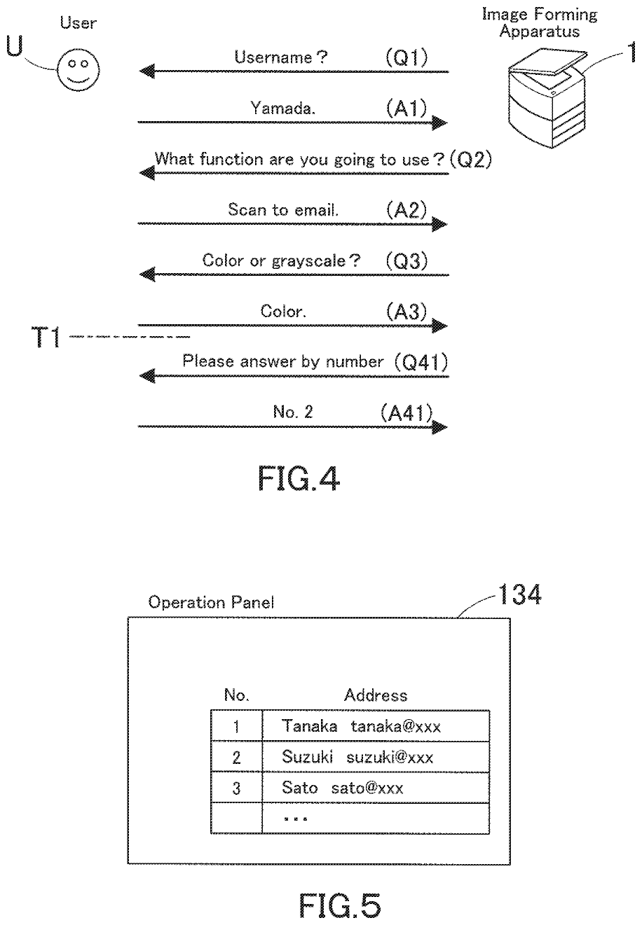

The background noise level starts to rise upon the start of document scan and goes above the predetermined threshold at the time T1. The image forming apparatus 1 then switches to the second mode and starts to output another audio question in the second mode, as illustrated in FIG. 4.

In the example of FIG. 4, the image forming apparatus 1 outputs an audio question Q41 “please answer by number” from the speaker 220 in the second mode, the closed-ended question mode and, at the same time, presents possible addresses as possible responses. In this embodiment, possible addresses are presented on the display 134 of the operation panel 130, as illustrated in FIG. 5. In the example of FIG. 5, possible addresses are presented in list font). as “No. 1, Tanaka, tanaka@xxx”, “No. 2, Suzuki, suzuki@xxx”, and “No. 3, Sate, sato@xxx”.

The user is thus prompted to select an address from the list displayed on the display 134. When the user responds with a spoken response A41 “No. 2”, for example, the microphone 210 inputs the spoken response. The image forming apparatus 1 receives the speech input and identifies the user's selected address by speech recognition. The image forming apparatus 1 thus sets the scan-to-email destination to the identified address. As described above, the image forming apparatus 1 compares a spoken response to each keyword by pattern matching in the second mode. So, the second mode, the closed-end question mode can overcome loud background noise. It is convenient that, in the second mode, the image forming apparatus 1 can identify a user's selected address correctly even when the background noise level goes above the threshold. It is not convenient that, in the first mode, the image forming apparatus 1 can fail in speech recognition and stop its operation when the background noise is loud, and this interferes with high-volume or emergency printing. The second mode serves as a solution to the inconvenience of the first mode.

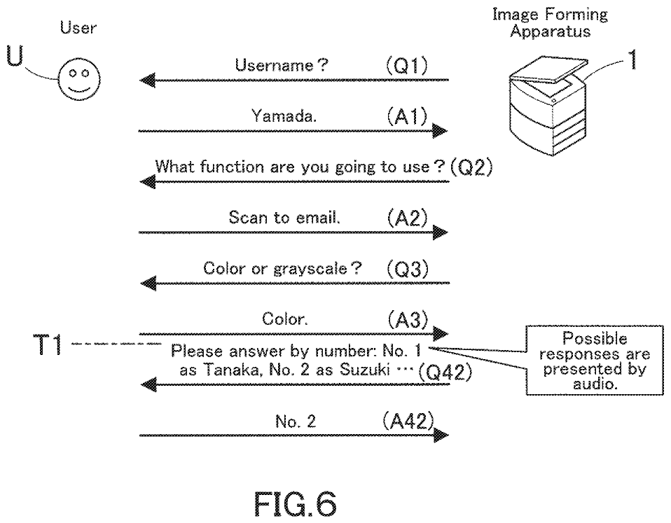

In the example of FIG. 4, possible addresses are presented on the display 134 of the operation panel 130, as illustrated in FIG. 5. Alternatively, possible responses (possible addresses) may be presented by audio as “please answer by number: No. 1 as Tanaka, No. 2 as Suzuki . . . ” (audio question Q42), as illustrated in FIG. 6. The user is thus prompted to select an address from the list presented by audio. The user responds with a spoken response A42 “No. 2”, for example.

Possible responses may be presented on the display 134 or by audio in descending order based on the number of times they have been used i.e. based on the frequency at which they were used. Alternatively, they may be presented on the display 134 or by audio in chronological order based on the date and time they were registered as possible addresses on the image forming apparatus 1. Either case will make it easier for the user to respond with a fixed response.

After that switching to the second mode, the image forming apparatus 1 may further switch o the first mode when the background noise level reaches or goes below the threshold.

As described above, in this embodiment, when the background noise level reaches or goes below the threshold, the image forming apparatus 1 outputs an audio question in the first mode, the open-ended question mode, for user convenience. When the background noise level goes above the threshold, the image forming apparatus 1 outputs an audio question in the second mode, the closed-ended question mode, for the accuracy of speech recognition. The image forming apparatus 1 is thus capable of achieving a compromise between user convenience and the accuracy of speech recognition. Furthermore, the image forming apparatus 1 may allow a privileged user such as an administrator to change the threshold.

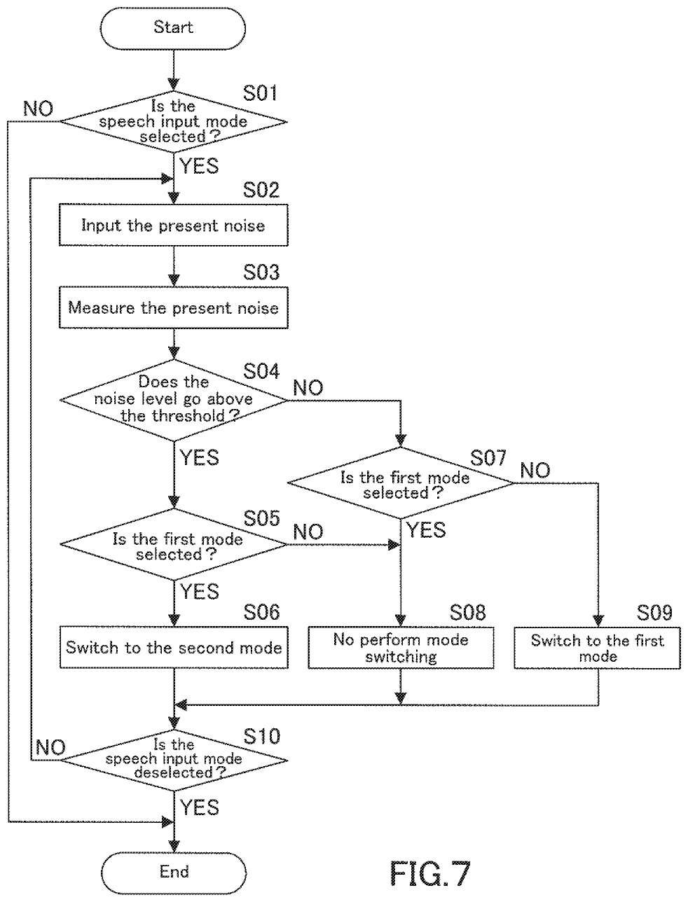

FIG. 7 is a flowchart representing an example of the operation of the image forming apparatus 1, switching between the first mode and the second mode during speech input. The image forming apparatus 1 performs the operations represented by the flowcharts including that of FIG. 7, by the CPU 101 of the controller 100 running operation programs stored on a recording medium such as the ROM 102.

In Step S01, it is judged whether or not the speech input mode is selected by a user; if the speech input mode is not selected (NO in Step S01), the routine terminates. If the speech input mode is selected (YES in Step S01), the present noise is inputted front the microphone 21 in Step S02, then is measured in Step S03.

In Step S04, it is judged the noise level goes above a predetermined threshold; if it goes above the threshold (YES in Step S04), it is further judged in Step SOS whether or not the first mode (the open-ended question mode) is currently selected. If the first mode is currently selected (YES in Step S05), mode switching is performed to select the second mode, the closed-ended question mode in Step S06. The routine they proceeds to Step S10. If the first, mode is not currently selected in Step S05 (NO in Step S05), mode switching is not performed in Step S05. The routine then proceeds to Step S10. This means, the second mode is kept.

If the noise level does not go above the threshold in Step S05 (NO in Step S04), it is further judged in Step S07 whether or not the first mode is currently selected. If the first mode is currently selected (YES in Step S07), mode switching is not performed in Step S05. The routine then proceeds to Step S10. This means, the first mode is kept. If the first mode is not currently selected in Step S07 (NO in, Step S07), mode switching is performed to select the first mode in Step S09. The routine then proceeds to Step S10.

In Step S10, it is judged whether or not the speech input mode is deselected by the completion of the job; if it is deselected (YES in Step S10), the routine terminates. If it is not deselected (NO in Step S10), the routine returns to Step S02.

In the above-described manner, the image forming apparatus 1 switches between the first mode and the second mode depending on whether or not the noise level goes above the threshold.

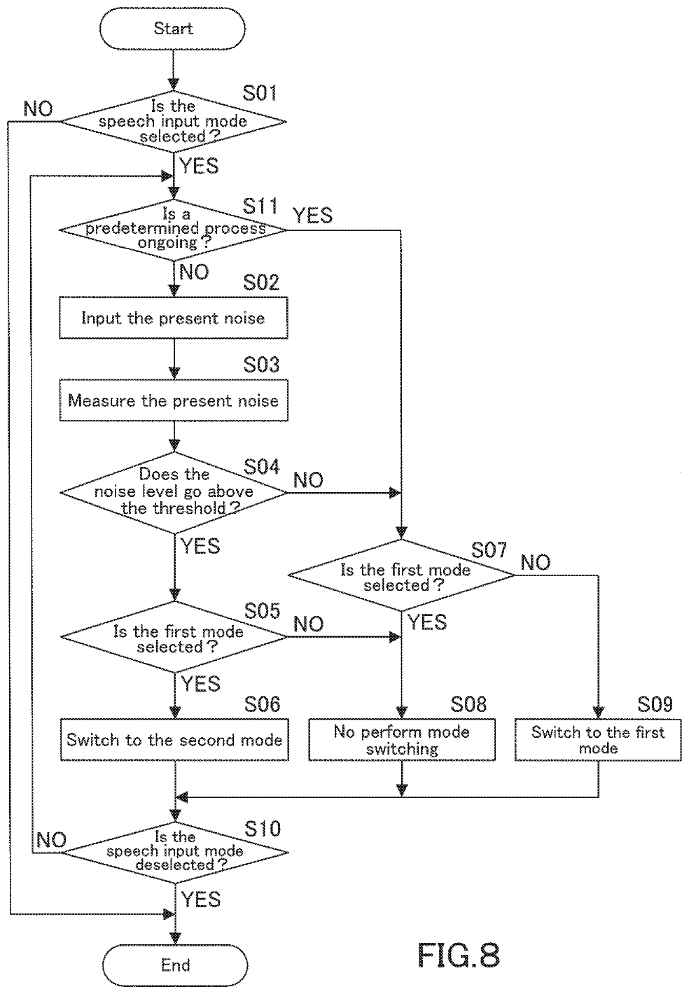

FIG. 8 is a flowchart representing another example of the operation of the image forming apparatus 1, switching between the first mode and the second mode during speech input. In this embodiment, the image firming apparatus 1 selects the first mode during a predetermined process that is a particular process causing small operational sound. During the predetermined process, the image forming apparatus 1 does not measure the noise level or judge whether or not the noise level goes above the threshold. In a quiet place, the background noise is mostly operational noise front the image forming apparatus 1. So, the background noise level from a particular process causing small operational sound is not expected to go above the threshold. The particular process causing small operational sound is image stabilization or warm-up, for example.

In Step S01, it is judged whether or not the speech input mode is selected by a user; if the speech input mode is not selected (NO in Step S01), the routine terminates. If the speech input mode is selected (YES in Step S01), it is further judged in Step S11 whether or not a predetermined process such as image stabilization or warm-up is ongoing. If such a predetermined process is ongoing (YES in Step S11), it is further judged in Step S07 whether or not the first mode is currently selected. If the first mode is currently selected (YES in Step S07), mode switching is not performed in Step S08. The routine then proceeds to Step S10. If the first mode is not currently selected in Step S07 (NO in Step S07), mode switching is performed to select the first mode in Step S09. The routine then proceeds to Step S10. In the above-described manner, the image forming apparatus 1 keeps the first mode or switches from the second mode to the first mode without depending on the noise level, during a predetermined process,

In Step S11, if such a predetermined process is not ongoing (NO in Step S11), the routine proceeds to Step S02.

Here, a detailed description on Steps S02 to S10 will be omitted since they are the same as Steps S02 to S10 of FIG. 8.

Hereinafter, yet another embodiment of the present invention will be described. In this embodiment, the image forming apparatus 1 does not receive or measure the present noise. Instead, the image forming apparatus 1 is configured to perform: storing past operational sound levels (noise levels) on a memory such as the storage device 110; reading out of the storage device 110 a past operational sound level from a job identical to an upcoming job; calculating a noise level from the upcoming job to be the past operational sound level; and comparing the calculated noise level to a threshold.

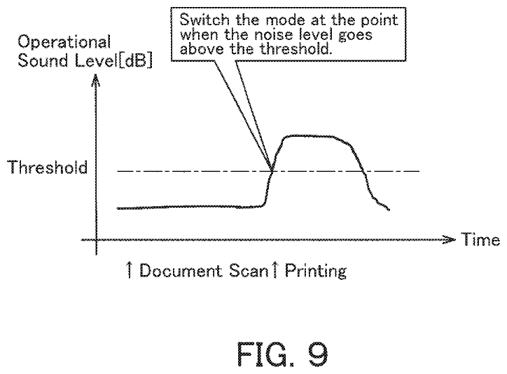

FIG. 9 is a graph indicating an example of a change in operational sound level (noise level) from a job. In the example of FIG. 9, the vertical axis represents operational sound level (noise level) from a copy job, and the horizontal axis represent time.

The operational sound level goes below the threshold during document scan by the image reading device 120. Upon the start of printing, the operation sound level starts to rise and soon goes above the threshold. Upon the completion of printing, the operation sound level starts to fall and soon reaches or go below the threshold. Such a change in operational sound level with respect to time is stored on a memory such as the storage device 110.

When a copy job is issued by a user, the image forming apparatus 1 reads out of the storage device 110 a change in operational sound level as indicated in FIG. 9, which is a past operational sound level from a copy job identical to the upcoming copy job. The image forming apparatus 1 further calculates a noise level from the upcoming copy job to be the past operational sound level and compares the calculated noise level to a threshold. With reference to the calculated noise level, the image forming apparatus 1 selects the second mode at the point in time when the present noise level goes above the threshold.

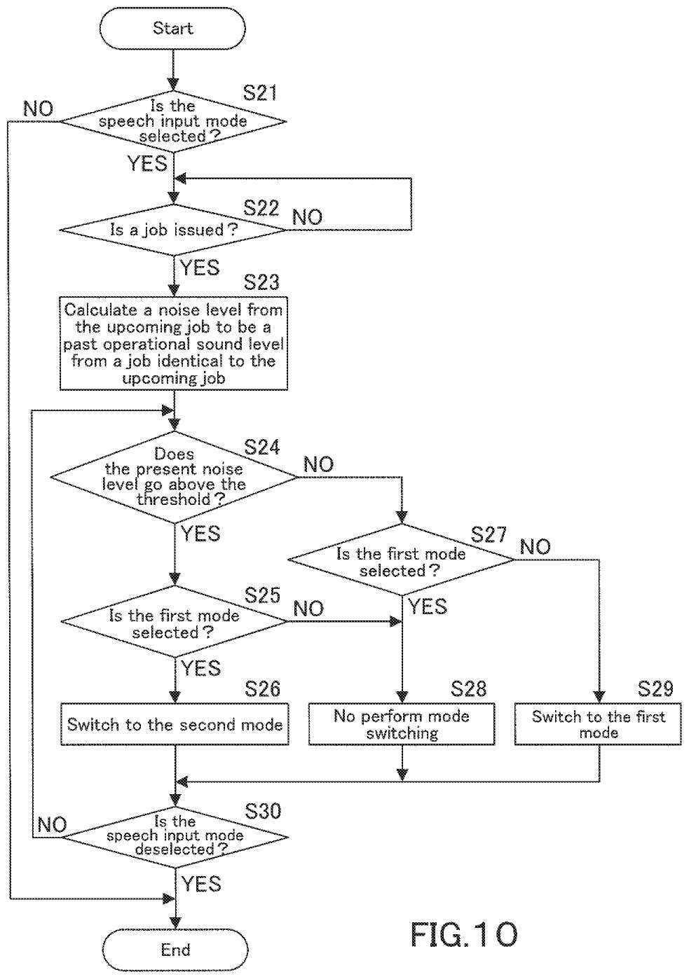

FIG. 10 is a flowchart representing the operation of the image forming apparatus 1, calculating a noise level front an upcoming job to he a past operational sound level from a job identical to the upcoming job and performing mode switching depending on the calculated noise level.

in Step S21, it is judged whether or not the speech input mode is selected by a user; if the speech input mode is not selected (NO in Step S21), the routine terminates. If the speech input mode is selected (YES in Step S21), it is further judged in Step S22 whether or not a job is issued. If it is not issued (NO in Step S22), the routine waits until it is issued. If it is issued (YES in Step S22), a change in operational sound level from a job identical to the upcoming job is read out of a memory such as the storage 110, and an operational sound level from the upcoming job is calculated to be the past operational sound level, in Step S23.

In Step S24, upon the start of the job, it is judged whether or not the present noise level from the ongoing job goes above the threshold, by comparing the calculated noise level to the threshold. If it goes above the threshold (YES in Step S24), it is further judged in Step S25 whether or not the first mode (the open-ended question mode) is currently selected. If the first mode is currently selected (YES in Step S25), mode switching is performed to select the second mode, the closed-ended question mode in Step S26. The routine then proceeds to Step S30. If the first mode is not currently selected in Step S25 (NO in Step S25), mode switching is not performed in Step S2S. The routine then proceeds to Step S30. This means, the second mode is kept.

If the noise level does not go above the threshold in Step S24 (NO in Step S24), it is further judged in Step S27 whether or not the first mode is currently selected. If the first mode is currently selected (YES in Step S27), mode switching is not performed in Step S28. The routine then proceeds to Step S30. This means, the first mode is kept. If the first mode is not currently selected in Step S27 (NO in Step S27), mode switching is performed to select the first mode in Step S29. The routine then proceeds to Step S30.

In Step S30, it is judged whether or not the speech input mode is deselected by the completion of the job: if it is deselected (YES in Step S30), the routine terminates. If it is not deselected (NO in Step S30), the routine returns to Step S24.

In the above-described manner, the image forming apparatus 1 calculates a noise level to be a past operational sound level and does need to receive or measure the present noise. This makes the operation simple.

In Step S23 of FIG. 10, a noise level from an upcoming job is calculated to be a past operational sound level from a job identical to the upcoming job. Alternatively, a noise level from an upcoming job may be calculated to be a combination of multiple past operational sound levels. For example, When a print job for printing ten sheets and stapling the ten sheets together is issued, the image forming apparatus 1 calculates a change in operational sound level (noise level) from the upcoming print job on the basis of a past operational sound level from printing one sheet and a past operational sound level from one-shot stapling. Specifically, the image forming apparatus 1 repeats ten times a change in operational sound level from printing one sheet and adds thereto a change in operational sound level from one-shot stapling.

In the above-described manner, the image funning apparatus 1 calculates a noise level from an upcoming job to be a combination of multiple past operational sound levels and does not need to store a past operational sound level from a job identical to the upcoming job. The image forming apparatus 1 is thus capable of switching between the first mode and second mode appropriately.

Hereinafter, yet another embodiment of the present invention will be described. In this embodiment, the image forming apparatus 1 is configured to calculate an operational sound level (noise level) from an upcoming job to be a past operational sound level from a job identical to the upcoming job, as in the embodiment of FIGS. 9 and 10.

The image forming apparatus 1 is further configured to select the second triode before the start of the upcoming job instead of at the point in time when the present noise level goes above the threshold, on condition that the calculated noise level from the upcoming job indicates to go above the threshold.

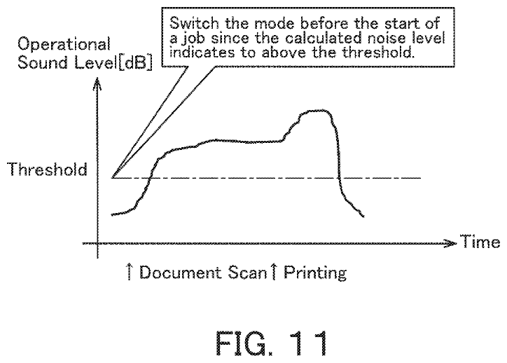

FIG. 11 is a graph indicating an example of a change in operational sound level (noise level) from a job. In the example of FIG. 11, the vertical axis represents operational sound level (noise level) from a copy job, and the horizontal axis represent time.

According to the graph of FIG. 11, the calculated operational sound level from a copy job indicates to rise and go above the threshold. To avoid a problem, the image forming apparatus 1 selects the second mode before the start of the copy job.

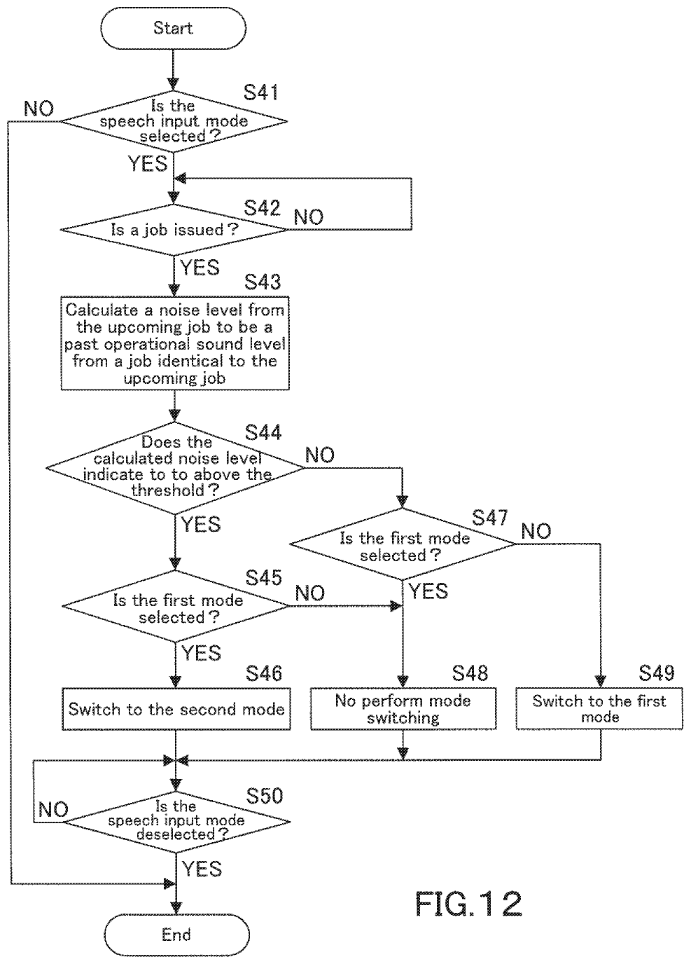

FIG. 12 is a flowchart representing the operation of the image farming apparatus 1, selecting the second mode before the start of a job.

In Step S41, it is judged whether or not the speech input mode is selected by a user; if the speech input mode is not selected (NO in Step S41), the routine terminates. If the speech input mode is selected (YES in Step S41), it is further judged in Step S42 whether or not a job is issued. If it is not issued (NO in Step S42), the routine waits until it is issued. If it is issued (YES in Step S42), a change in operational sound level from a job identical to the upcoming job is read out of a memory such as the storage 110, and an operational sound level from the upcoming job is calculated to be the past operational sound level, in Step S43. In this step, it may be calculated to be a combination of the multiple past operational sound levels.

In Step S44, it is judged whether or not the calculated noise level indicates to go above the threshold. If it indicates to go above the threshold (YES in Step S44), it is further judged in Step S45 whether or not the first mode (the open-ended question mode) is currently selected. If the first mode is currently selected (YES in Step S45), mode switching is performed to select the second mode, the closed-ended question mode in Step S46. The routine then proceeds to Step S50. If the first mode is not currently selected in Step S45 (NO in Step S45), mode switching is not performed in Step S48. The routine then proceeds to Step S50. This means, the second mode is kept.

If the calculated noise level does not indicate to go above the threshold in Step S44 (NC) in Step S44), it is further judged in Step S47 whether or not the first mode is currently selected. If the first mode is currently selected (YES in Step S47), mode switching is not performed in Step S48. The routine then proceeds to Step S50. This means, the first mode is kept. If the first mode is not currently selected in Step S47 (NO in Step S47), mode switching is performed to select the first mode in Step S49. The routine then proceeds to Step S50.

In Step S50, it is judged whether or not the speech input mode is deselected by the completion of the job, for example; if it is not deselected (YES in Step S50), the routine waits in Step S24 until it is deselected. If it is deselected (YES in Step S50), the routine terminates.

In the embodiment of FIGS. 11 and 12, on condition that a calculated noise level from an upcoming job indicates to go above the threshold, the image forming apparatus 1 selects the second mode before the start of the upcoming job instead of at the point in time the present noise level goes above the threshold. The image forming apparatus 1 does need to receive or measure the present noise. This makes the operation simple.

While some embodiments of the present invention have been described in details herein it should be understood that the present invention is in no way limited to the foregoing embodiments.

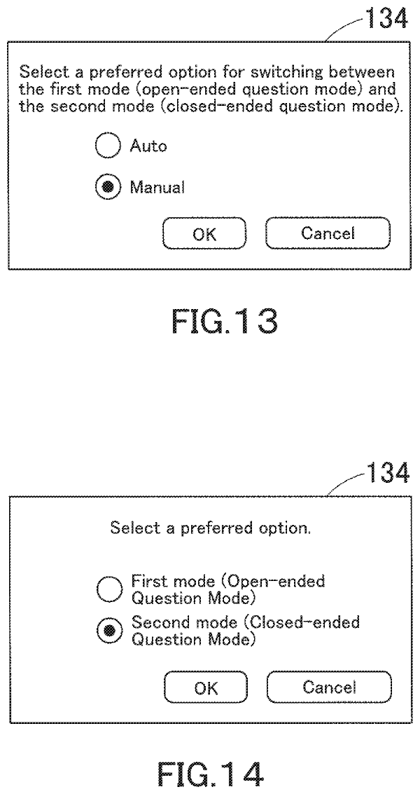

For example, the image foaming apparatus 1 switches between the first mode and the second mode mechanically. Alternatively, the image forming apparatus 1 may allow a user to switch between the first mode and the second mode. In this case, when the speech output mode is enabled, the image forming apparatus 1 displays a preference screen as illustrated in FIG. 13 on the display 134 of the operation panel 130. In the screen illustrated in FIG. 13, the options of “auto” and “manual” are presented along with a message prompting a user to select either of them for switching between the first mode (open-ended question mode) and the second mode (closed-ended question mode). The user can submit the selected mode by pressing the OK button. The user can return to the previous screen by pressing of the cancel button.

The user can select auto switch to allow the image forming apparatus 1 to perform the operations in accordance with the flow harts of FIGS. 7, 8, 10, and 12. The user can select manual switch to proceed to a mode preference screen as illustrated in FIG. 14. in the screen illustrated in FIG. 14, the options of “first mode” and “second mode” are presented along with a message “please select your preferred mode”, prompting the user to select either of them. The user can submit the selected mode by pressing the OK button, and the image forming apparatus 1 then switches to the user's selected mode. The user can return to the screen of FIG. 13 by pressing the cancel button.

When the first mode or the second mode is selected by the user, the image forming apparatus 1 outputs an audio question in the selected mode not depending on the noise level. The image forming apparatus 1 may further allow the user to select the first mode or the second mode during speech input.

As described above, the image forming apparatus 1 allows a user to switch between the first mode and the second mode, and the user can select the first mode anytime he/she feels the background noise is too loud during speech input, for example. The image forming apparatus 1 is thus capable of reflecting a user's intention and protecting the accuracy of speech recognition.

Although one or incite embodiments of the present invention have been described and illustrated in detail, the disclosed embodiments are made for purposes of illustration and example only and not limitation. The scope of the present invention should be interpreted by terms of the appended claims.

What is claimed is:

1. An image processing apparatus comprising:
a first processor that outputs an audio question for a user from a speech output device;
a third processor that receives a spoken response of the user to the audio question, the spoken response being inputted from a speech input device; and
a second processor that takes an appropriate image processing action to the spoken response received by the third processor,
wherein a first mode and a second mode are supported, and the second mode is limited in possible responses to the audio question, as contrasted with the first mode, the image processing apparatus thither comprising a fourth processor that switches between the first mode and the second mode, wherein the first processor outputs the audio question for the user from the speech output device in the first or second mode being selected by the fourth processor,

2. The image processing apparatus according to claim 1, wherein the first mode is an open-ended question mode prompting the user to respond to the audio question with a free-form spoken response, and the second mode is a closed ended question mode prompting the user to respond to the audio question with a fixed spoken response, the fixed spoken response being selected from possible responses.

3. The image processing apparatus according to claim 2, further comprising a display,
wherein, when the first processor outputs the audio question from the speech output device in the second mode, the first processor further presents the possible responses in list form on the display, and
wherein the user responds with the fixed spoken response, the fixed spoken response being, selected from the possible responses presented on the display.

4. The image processing apparatus according to claim 2,
wherein, when the first processor outputs the audio question from the speech output device in the second mode, the first processor farther presents the possible responses by audio, and
wherein the user responds with the fixed spoken response, the fixed spoken response being selected from the possible responses presented by audio.

5. The image processing apparatus according to claim 3, wherein the possible responses are presented in descending order based on a number of times the possible responses have been used.

6. The image processing apparatus according to claim 3, wherein the possible responses are presented in chronological order based on a date and time at which the possible responses were registered on the image processing apparatus.

7. The image processing apparatus according to claim 1, wherein the fourth processor allows the user to switch between the first mode and the second mode.

8. The image processing apparatus according to claim 1,
wherein the fourth processor switches between the first mode and the second mode depending on a background noise level surrounding the image processing apparatus, and
wherein, when the background noise level goes above a predetermined threshold, the fourth processor switches from the first mode to the second mode.

9. The image processing apparatus according to claim 8, wherein the background noise level is an operational noise level from the image processing apparatus.

10. The image processing apparatus according to claim 8, wherein the background noise level is a present background noise level inputted from the speech input device, and the fourth processor compares the present background noise level to the predetermined threshold.

11. The image processing apparatus according to claim 8, further comprising a memory that stores a past operational noise level from each process, wherein the fourth processor calculates a background noise level surrounding the image processing apparatus from an upcoming process to he the past operational noise level from a process identical to the upcoming process, the past operational noise level being stored on the memory.

12. The image processing apparatus according to claim 11, wherein the fourth processor calculates the background noise level surrounding the image processing apparatus from the upcoming process on the basis of the past operational noise level from a process identical to each part of the upcoming process, the past operational noise level being stored on the memory.

13. The image processing apparatus according to claim 1, wherein the fourth processor does not switch from the first mode to the second mode during a predetermined process.

14. The image processing apparatus according to claim 8, wherein the fourth processor switches from first mode to the second mode at a first point in time when the background noise level goes above the predetermined threshold during a process, and the fourth processor switches from the second mode to the first mode at a second point in time when the background noise level roaches or goes below the predetermined threshold during the process.

15. The image processing apparatus according to 11, wherein, on condition that the calculated background noise level from the upcoming process indicates to go above the predetermined threshold, the fourth processor selects the second mode before start of the upcoming process instead of at the first point in time.

16. A non-transitory computer-readable recording medium storing a program for a computer of an image processing apparatus to execute:
outputting an audio question for a user from a speech output device;
receiving a spoken response of the user to the audio question, the spoken response being inputted from a speech input device; and
taking an appropriate image processing action to the spoken response being received,
wherein a first mode and a second mode are supported, and the second mode is limited in possible responses to the audio question, as contrasted with the first mode, the program for the computer to further execute switching between the first mode and the second mode, wherein the audio question is outputted from the speech output device in the first or second mode being selected.
